(19) United States
(12) Patent Application Publication
(10) Pub. No.: US 2003/0113200 A1
(43) Pub. Date: Jun. 19, 2003

(54) Handling device and method for loading and unloading work pieces from trays

(76) Inventors: Shih Hsiung Hoe, Singapore (SG); Hua Kee Lee, Singapore (SG); Siak Shua Leow, Singapore (SG); Pueh Leng Ng, Singapore (SG); Chee Suan Low, Singapore (SG); Cecilia Hui San Woo, Singapore (SG)

Correspondence Address: Mitchell K. McCarthy, Seagate Technology LLC, Intellectual Property Dept. - OKM270, 10321 West Reno, Oklahoma City, OK, 73127, US

(21) Appl. No.: 10/184,233

(22) Filed: Jun. 28, 2002

Related U.S. Application Data
(60) Provisional application No. 60/337,270, filed on Dec. 5, 2001.

(51) Int. Cl. B65G 57/00

(52) U.S. Cl. 414/788.4

(57) ABSTRACT

An apparatus and associated method for presenting trays from a first plurality of stacked trays to a pick and place device for loading or unloading work pieces to or from the trays, and for subsequently restacking the trays to a second plurality of stacked trays. A handling device comprises a frame defining a tray loading zone receivingly engaging the first plurality of stacked trays for singulating the trays. The frame furthermore defines a tray unloading zone different from the tray loading zone receivingly engaging the trays for stacking with the second plurality of stacked trays. The frame furthermore defines a handling zone between the loading and unloading zones operatively presenting the singulated trays to the pick and place device. The handling device further comprises a singluating device in the tray loading zone adapted for separating the trays from the first plurality of stacked trays. A stacking device in the tray unloading zone is adapted for joining the trays with the second plurality of stacked trays. A shuttle is adapted for simultaneously moving one of the trays from the tray loading zone to the work zone while moving another of the trays from the work zone to the tray unloading zone.

### CROSS REFERENCE TO RELATED APPLICATIONS

This application claims the benefit of U.S. Provisional Application No. 60/337,270.

### FIELD OF THE INVENTION

This invention relates generally to the field of automated fabrication devices and more particularly without limitation to a device and associated method for loading and unloading work pieces from a stack of trays containing the work pieces.

### BACKGROUND OF THE INVENTION

Tremendous gains in manufacturing productivity and quality have been realized by the application of modem automation techniques to production processes. Most of the earliest advancements involved automating fabrication processes, such as by the use of numerically controlled tooling machines. Typically, the work piece was manually installed into a fixture, or “fixtured,” the computer-controlled process performed, and then the work piece was manually removed from the fixture. Subsequent advancements improved the material handling aspects of the process, such as with the proliferation of robotics. Today, it's not unusual to see all aspects of the fabrication process from raw material to packaging performed by automated flexible manufacturing cells connected by automated material transfer devices.

Flexible manufacturing approaches are typically able to process different types of parts so that one cell can be used in the manufacture of different products. For example, a packaging cell might be able to receive different size containers for use in packaging different sizes or types of products. This flexibility furthermore aids the development of new and different products because the likelihood of consequential costly modifications and downtime to the manufacturing process are greatly diminished.

One such process that is particularly difficult to automate is the loading or unloading of work pieces into or from a holding tray, especially when a plurality of stacked trays are considered. Typically, the stacked trays are staged in a loading zone for singulating, and then the trays are restacked as they are individually emptied or loaded, as the case may be. Automatically picking and placing work pieces from or to the trays while they are being unstacked and stacked can be less efficient than human handling. This is especially true where different sizes of trays and different types of work pieces are contemplated. For this reason, it is not unusual to see human assistance necessary in operations requiring loading or unloading of trays. The penalty associated with relying on manual intervention can be very significant.

It has been determined that optimal automated loading and unloading can be achieved by shuttling trays from a first plurality of stacked trays to a second plurality of stacked trays, and staging the trays at a handling zone therebetween the stacked trays whereat the singulated tray can be operatively presented to an automatic pick and place device. By simultaneously shuttling a tray from the first stack to the handling zone while shuttling another tray from the handling zone to the second stack, and by singulating and stacking the trays while the pick and place device operates, then continuous picking and placing operations can be performed while the trays are being shuttled. It is to these improvements and others as exemplified by the description and appended claims that embodiments of the present invention are directed.

### SUMMARY OF THE INVENTION

The embodiments of the present invention contemplate a handling device presenting trays from a first plurality of stacked trays to a pick and place device for loading or unloading work pieces to or from the trays, and for subsequently restacking the trays to a second plurality of stacked trays. The handling device comprises a frame defining a tray loading zone receivingly engaging the first plurality of stacked trays for singulating the trays. The frame furthermore defines a tray unloading zone different from the tray loading zone receivingly engaging the trays for stacking with the second plurality of stacked trays. The frame furthermore defines a handling zone between the loading and unloading zones operatively presenting the singulated trays to the pick and place device. The handling device further comprises a singluating device in the tray loading zone adapted for separating the trays from the first plurality of stacked trays. A stacking device in the tray unloading zone is adapted for joining the trays with the second plurality of stacked trays. A shuttle is adapted for simultaneously moving one of the trays from the tray loading zone to the handling zone while moving another of the trays from the handling zone to the tray unloading zone.

The embodiments of the present invention contemplate a method for presenting trays from a first plurality of stacked trays to a pick and place device for loading or unloading work pieces to or from the trays, and for subsequently restacking the trays to a second plurality of stacked trays. The method comprises: singulating a first tray in the first plurality of stacked trays; shuttling the first tray to a handling zone operatively adjacent the pick and place device; moving work pieces from or to the tray in the handling zone with the pick and place device and simultaneously singulating a second tray in the first plurality of stacked trays; when the handling operations on the first tray are complete, simultaneously shuttling the first tray from the handling zone to the second plurality of stacked trays while shuttling the second tray from the first plurality of stacked trays to the handling zone.

These and various other features as well as advantages which characterize the present invention will be apparent upon reading of the following detailed description and review of the associated drawings.

### BRIEF DESCRIPTION OF THE DRAWINGS

FIG. 1 is an isometric view of a handling device constructed in accordance with embodiments of the present invention.

FIG. 2 is a block diagram of a handling device constructed in accordance with prior art approaches wherein pick and place operations are performed on trays while in the tray loading zone.

FIG. 3 is a block diagram of a handling device constructed in accordance with prior art approaches wherein pick and place operations are performed on trays while in the tray unloading zone.

FIG. 4 is a block diagram of a handling device constructed in accordance with prior art approaches wherein the pick and place operations are performed on trays both in the tray loading zone and the tray unloading zone.

FIG. 5 is a block diagram of the handling device of FIG. 1 wherein the pick and place operations are performed on trays in a handling zone interposed between the tray loading zone and the tray unloading zone.

FIG. 6 is a detail view of a portion of the first plurality of stacked trays in the tray loading zone being indexed to the singulating position.

FIG. 7 is a detail view of a portion of the first plurality of stacked trays in the tray loading zone being singulated by shuttling the end effector adjacent the outermost tray.

FIG. 8 is a view similar to FIG. 7 but showing the end effector extended to grippingly engage the outermost tray.

FIG. 9 is a view similar to FIG. 8 but showing the negative pressure applied and the end effector retracted to separate the outermost tray from the first plurality of stacked trays.

FIG. 10 is a flowchart illustrating a method for presenting trays from a first plurality of stacked trays to a pick and place device in accordance with embodiments of the present invention.

### DETAILED DESCRIPTION

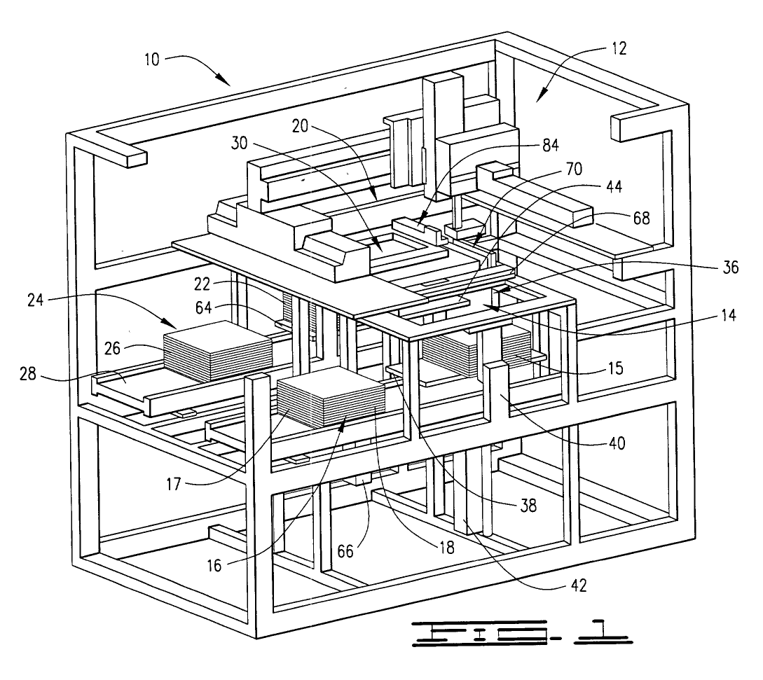

Referring to the drawings in general, and more particularly to FIG. 1, shown therein is a handling device 10 generally adapted for presenting trays from a first plurality of stacked trays 15 to a pick and place device 12 for loading or unloading work pieces to or from the trays, and for subsequently restacking the trays to a second plurality of stacked trays 22.

The handling device 10 comprises a frame defining a tray loading zone 14 receivingly engaging the first plurality of stacked trays 15 for singulating the trays. An infeed buffer zone 16 can queue a desired number of stacks of trays such as stack 17. A powered conveyor 18 can be used to transport the stack of trays 17 in the infeed buffer zone 16 to the tray loading zone 14.

The handling device 10 further comprises a tray unloading zone 20 different from the tray loading zone 14 and receivingly engaging the trays for stacking with the second plurality of stacked trays 22. An outfeed buffer zone 24 can queue a desired number of stacks such as stack 26. A powered conveyor 28 can be used to transport the stack of trays 26 from the tray unloading zone 20 to the outfeed buffer zone 24.

The handling device 10 further comprises a handling zone 30 between the tray loading zone 14 and the tray unloading zone 20, where singulated trays are operatively presented to the pick and place device 12. In this manner, the pick and place device 12 can operate continuously as the trays are shuttled from the first plurality of stacked trays 15 to the second plurality of stacked trays 22.

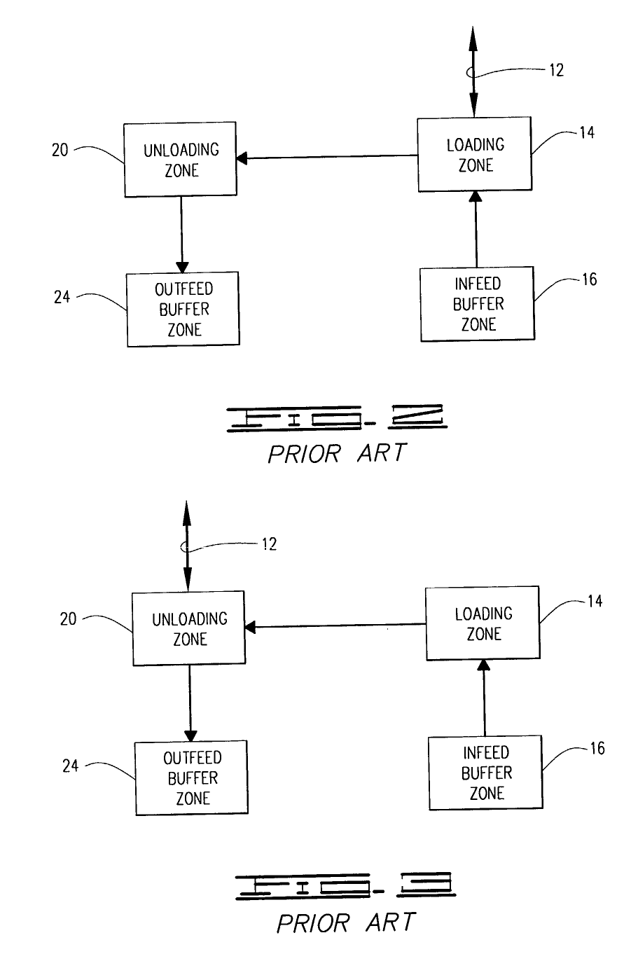

FIGS. 2-4 diagrammatically illustrate prior art approaches that do not provide such a continuous pick and place action. In FIG. 2 the device comprises a tray loading zone 14 and a tray unloading zone 20, fed by respective infeed buffer zone 16 and outfeed buffer zone 24 in a similar fashion as the device of FIG. 1. The pick and place device 12, however, loads or unloads work pieces from the outermost tray in the first plurality of stacked trays 15 in the tray unloading zone 14. When operations on a tray are completed, for example when a tray is completely unloaded, the pick and place operations must be temporarily suspended during the time that the unloaded tray is shuttled to the tray unloading zone 20 and the next tray in the first plurality of stacked trays 15 is singulated for pick and place operations.

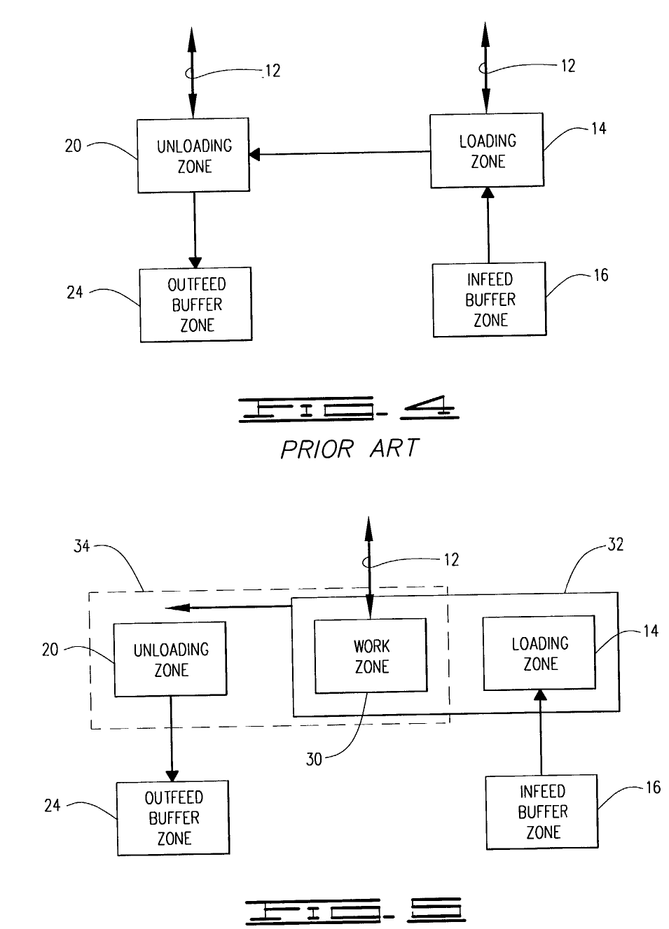

FIG. 3 illustrates another approach similar to that of FIG. 2 but wherein the pick and place device 12 operates on trays after they are shuttled to the second plurality of stacked trays 22 in the tray unloading zone 20. Like the approach of FIG.2, the pick and place operations must be temporarily suspended during the time that the next tray is shuttled and stacked in the tray unloading zone 20.

FIG. 4 illustrates yet another approach wherein the pick and place device 12 can operate in trays in either the tray loading zone 14 or the tray unloading zone 20. This approach can be more efficient than the approaches of FIGS. 2 and 3 by permitting the tray to be partially unloaded in the tray unloading zone 14 while the previous tray is being stacked in the tray unloading zone 20. Then the tray can be shuttled and unloaded completely in the tray unloading zone 20 while the next tray in the first plurality of stacked trays 15 is singulated. A disadvantage of this approach, however, is the increased complexity of the pick and place device 12, which either must be duplicated to operate in the different zones or must be made to operate over a relatively larger envelope. Increased cost is the result in both cases, and increased travel time for the pick and place device 12 in the latter case.

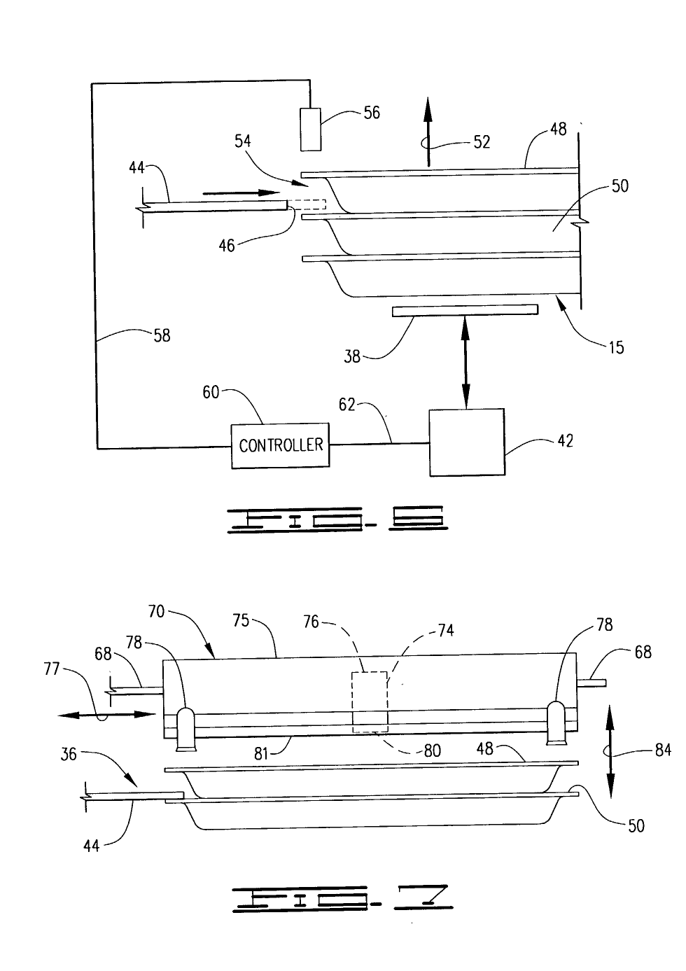

FIG. 5 diagrammatically illustrates the device of FIG. 1 in accordance with an embodiment of the present invention. The handling device 10 comprises the tray loading zone 14 supporting the first plurality of stacked trays 15 and the tray unloading zone 20 supporting the second plurality of stacked trays 22. The handling device 10 further comprises means for shuttling trays from the first 15 to the second 22 plurality of stacked trays and staging the trays therebetween in the handling zone 30 adapted for communicating with the pick and place device 12 for continuous picking and placing operations on work pieces to and from the trays.

The means for shuttling is characterized by a shuttle adapted for simultaneously moving one of the trays from the tray loading zone 14 to the work zone 30 while moving another of the trays from the work zone 30 to the tray unloading zone 20. Accordingly, the means for shuttling is characterized by a process comprising: (a) moving a shuttle to a first position 32 wherein a first end effector (not shown) is adjacent the first plurality of stacked trays; (b) gripping the outermost tray in the first plurality of stacked trays with the end effector; (c) gripping a tray in the handling zone 30 with a second end effector; (d) moving the shuttle to a second position 34 whereat the first end effector is adjacent the handling zone 30 and the second end effector is adjacent the tray unloading zone 20; and (e) releasing the outermost tray in the handling zone 30 with the first end effector and releasing the tray in the tray unloading zone 20 with the second end effector.

Continuous picking and place operations are possible wherein the means for shuttling is characterized by a process further comprising simultaneously moving the shuttle to the first position 32 while the pick and place device 12 is loading or unloading work pieces to or from the tray in the handling zone 30. Furthermore, continuous picking and placing operations are possible wherein the means for shuttling is characterized by a process further comprising simultaneously moving the shuttle between the first position 32 and the second position 34 while moving the second plurality of stacked trays to a stacking position for receivingly engaging a tray for stacking. Furthermore, continuous picking and placing operations are possible wherein the means for shuttling is characterized by a process further comprising simultaneously moving the shuttle between the first position 32 and the second position 34 while moving the first plurality of stacked trays to a singulating position for separating a tray.

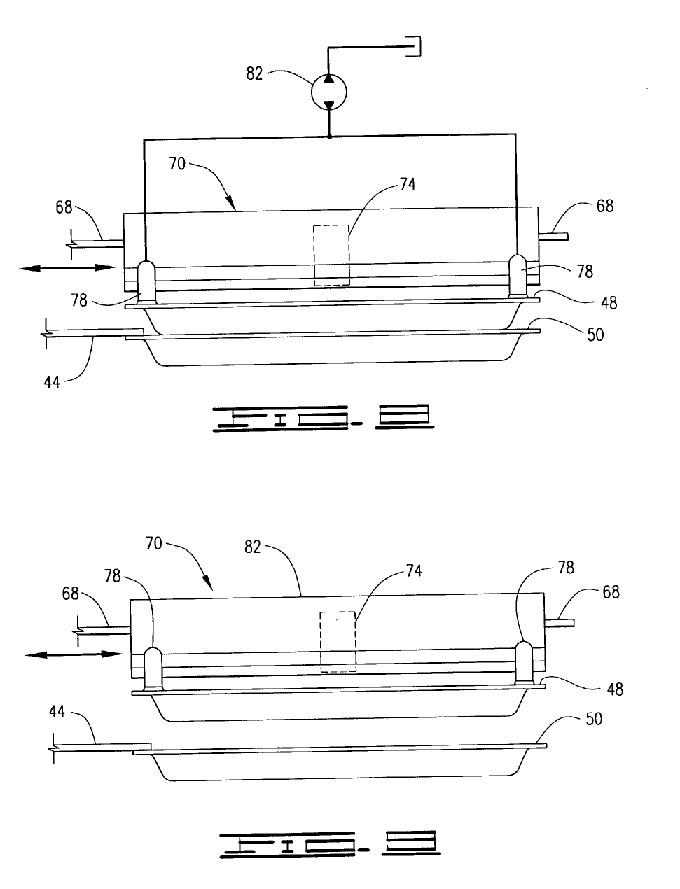

Returning to FIG. 1, the handling device 10 comprises a singulating device 36 in the tray loading zone 14 adapted for separating the trays from the first plurality of stacked trays 15. The singulating device 36 comprises a platform 38 supporting the first plurality of stacked trays 15 that are stacked substantially along a longitudinal direction. In FIG. 1 the platform is moveable along the longitudinal direction by opposing supporting linear slides 40. An actuator 42 indexes the first plurality of stacked trays 15 in the longitudinal direction to place the outermost tray in a singulating position. In the singulating position a stripper member 44 operatively extends from a retracted position to an extended position. FIG. 6 illustrates the retracted position clearingly permits moving the first plurality of stacked trays 15 past a distal end 46 of the stripper member 44. In the extended position, shown in broken lines, the distal end 46 of the stripper member 44 is receivingly disposed between an outermost tray 48 and the adjacent tray 50. An upward force 52 applied to the outermost tray 48 is opposed by the stripper member 44 which retains the other trays in the first plurality of stacked trays 15. This permits separating the outermost tray 48 from the first plurality of stacked trays 15. This stripping force is particularly useful when the trays in the first plurality of stacked trays 15 are nested.

Accordingly, the actuator 42 (FIG. 1) indexes the first plurality of stacked trays 15 to a “singulating position.” Singulating position for the purposes of this description mean a longitudinal placement of the first plurality of stacked trays 15 such that a gap 54 between the outermost tray 48 and the adjacent tray 50 is aligned with the position of the stripper member 44 in the extended position. Preferably, the indexing is done automatically to avoid the need for human intervention to move the first plurality of stacked trays 15 in the singulating position. For example, FIG. 6 diagrammatically shows the manner in which a sensor 56, such as a proximity sensor, can be used to indicate when the singulating position is achieved. The sensor 56 sends the indicative signal 58 to a controller 60 which, in turn, sends a control signal 62 to the actuator 42 to position the platform 38.

In a similar manner, FIG. 1 illustrates how the second plurality of stacked trays 22 can be supported upon a platform 64 that is moveable by an actuator 66 to position the second plurality of stacked trays 22 in a longitudinal direction along which the trays are stacked. By using a sensor (not shown) and associated control devices, as in FIG. 6, the second plurality of stacked trays 22 can be automatically indexed to a “stacking position.” Stacking position for the purposes of this description means a longitudinal position of the outermost tray such that it is receivingly engageable with another tray to be stacked thereagainst.

The handling device 10 furthermore comprises a shuttle 68 that is adapted for simultaneously moving one of the trays from the tray loading zone 14 to the work zone 30 while moving another of the trays from the work zone 30 to the tray unloading zone 20. The shuttle is operatively moveable adjacent the outermost tray 48 in the first plurality of stacked trays 15, such as by connection to a linear actuator. FIG. 7 shows the shuttle 68 moved in directions 77 to the first position 32 (FIG. 5). The singulating device 36, partially described above, further comprises an end effector 70 supported by the shuttle 68 adapted for gripping the outermost tray 48 in the first plurality of stacked trays 15 and displacing the outermost tray 48 away from the first plurality of stacked trays 15.

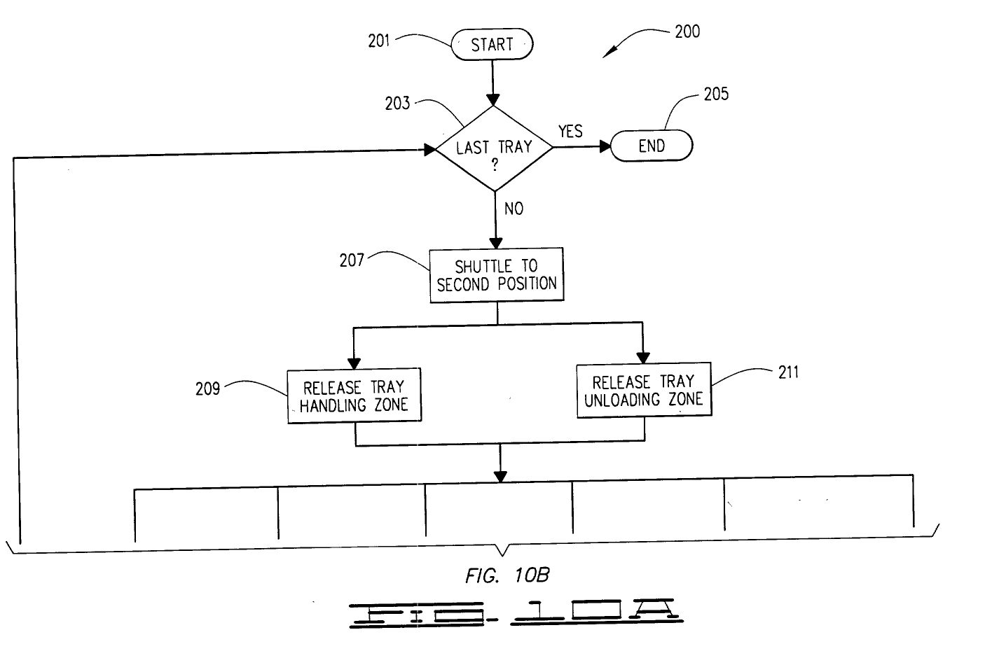

FIGS. 7-9 illustrate how the singulating device 36 and the shuttle 68 cooperate to separate and transfer the trays from the first plurality of stacked trays 15. The end effector 70 comprises a linear actuator 74 having a fixed end 76 attached to the shuttle 68, such as by way of a mounting block 75. The mounting block 75 can thus be reciprocated between the first position 32 (FIG. 5) and the second position 34 (FIG. 5) by movement of the shuttle 68 in directions 77. One or more suction lifting devices 78 attached to an extensible distal end 80 of the actuator 74, such as by a moveable mounting block 81. The suction lifting devices 78 can be reciprocated in directions 84 by activation of the actuator 74. In FIG. 7 the suction lifting devices 78 are clearingly retracted from the outermost tray 48. In FIG. 8 the actuator 74 is extended to pressingly engage the suction lifters 78 against the outermost tray 48. The suction lifters 78 are in fluid communication with a vacuum source, such as a vacuum pump 82 shown diagrammatically in FIG. 8. FIG. 9 shows the vacuum source imparting a negative pressure to the suction lifters 78 and the actuator 74 retracted to separate the outermost tray 48 from the first plurality of stacked trays 15.

The handling device 10 can comprise a second end effector 84 (FIG. 1) supported by the shuttle 68 adapted for simultaneously gripping a tray in the tray handling zone 30 when the shuttle 68 is in the first position 32 (FIG. 5); in other words, while the end effector 70 is gripping the outermost tray 48 (FIG. 9) in the tray loading zone 14.

The shuttle is operatively moveable in directions 77 (FIG. 7) between the first position 32 (FIG. 5) and the second position 34 (FIG. 5). The first position 32 is defined by the end effector 70 being adjacent the tray loading zone 14 and the end effector 84 being adjacent the handling zone 30. The second position 34 is defined by the end effector 70 being adjacent the handling zone 30 and the end effector 84 being adjacent the tray unloading zone 20. Accordingly, the trays are shuttled from the first plurality of stacked trays 15 to the second plurality of stacked trays 22 by a process comprising the following steps: moving the shuttle 68 to the first position 32; gripping the outermost tray 48 in the first plurality of stacked trays 15 with the end effector 70; gripping the tray in the handling zone 30 with the end effector 84; moving the shuttle 68 to the second position 34; releasing the outermost tray 48 in the handling zone 30 with the end effector 70; and releasing the tray in the tray unloading zone 20 with the end effector 84.

After releasing the trays in the respective zones, the actuator 74 in the end effector 70, 84 can be retracted to clearingly permit the shuttle 68 to move between the first position 32 (FIG. 5) and the second position 34 (FIG. 5) without engaging the trays. This advantageously permits the shuttle 68 to be moved while the pick and place operations are occurring on the tray in the handling zone 30. Thus, the outermost tray 48 in the first plurality of stacked trays 15 can be singulated before the pick and place operation is completed. This eliminates the delay associated with singulating the next tray after the pick and place operations, as is common in prior art approaches. Similarly, the tray just shuttled out of the handling zone 30 can be stacked while the pick and place operations are performed in the next tray in the handling zone 30. Also, stacks of trays can be moved within the infeed and outfeed buffer zones 16, 24 without disrupting the pick and place operations.

This novel feature of the embodiments of the present invention permits the trays to be moved in accordance with a process further comprising simultaneously moving the shuttle 68 to the first position 32 (FIG. 5) while the pick and place device 12 is loading or unloading work pieces to or from the tray in the handling zone 30. Furthermore, the process further comprises simultaneously moving the shuttle 68 between the first position 32 and the second position34 and moving the second plurality of stacked trays 22 to the stacking position. Furthermore, the process further comprises simultaneously moving the shuttle 68 between the first position 32 and the second position 34 and moving the first plurality of stacked trays 15 to the singulating position.

In other embodiments of the present invention a reference surface is defined in the handling zone 30 adapted for positively positioning a tray relative to the pick and place device 12. Also, it may be advantageous to provide a clamp that is moveable to fix the tray positioned by the reference surface in the handling zone 30.

In addition to the apparatus described hereinabove, the embodiments of the present invention contemplate a novel method for presenting trays from a first plurality of stacked trays 15 to a pick and place device 12 for loading or unloading work pieces to or from the trays, and for subsequently restacking the trays to a second plurality of stacked trays 22. The method comprises the following: singulating the first tray 48 in the first plurality of stacked trays 15; shuttling the first tray 48 to a handling zone 30 operatively adjacent the pick and place device 12; moving work pieces from or to the first tray in the handling zone 30 with the pick and place device 12 and simultaneously singulating the second tray 50 in the first plurality of stacked trays 15; and when the handling operations on the first tray 48 are complete, simultaneously shuttling the first tray 48 from the handling zone 30 to the second plurality of stacked trays 22 while shuttling the second tray 50 from the first plurality of stacked trays 15 to the handling zone 30. Furthermore, the singulating step comprises retaining the trays other than the first tray 48 in the first plurality of stacked trays 15 while the first tray 48 is separated. Furthermore, the method comprises clamping the tray in the handling zone 30 while picking and placing work pieces.

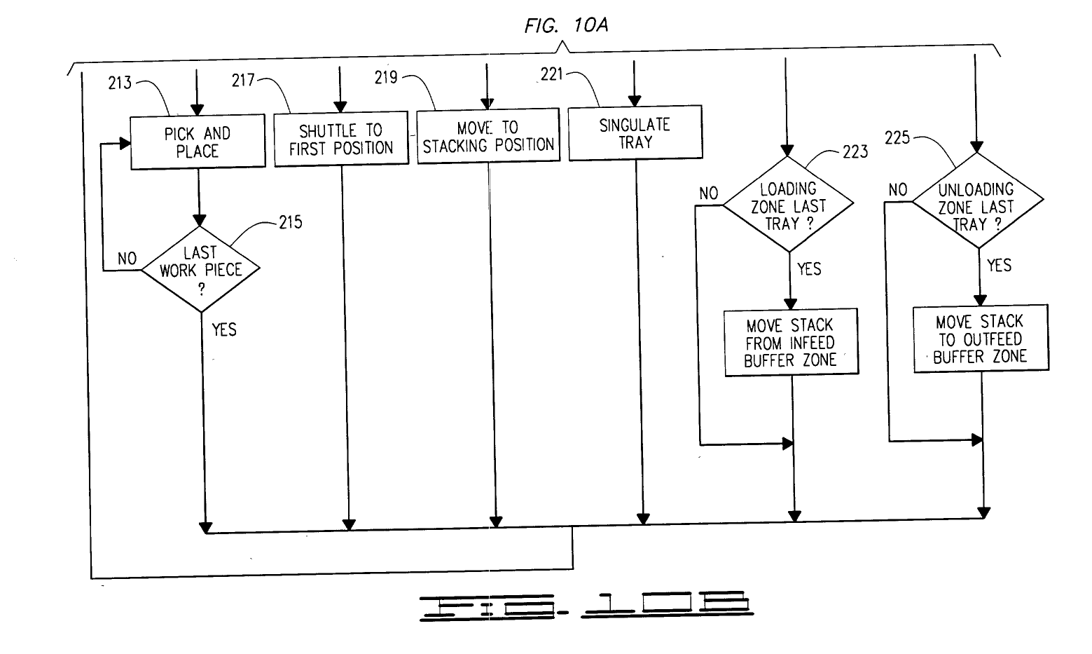

FIG. 10 is a flow chart of a method 200 for presenting trays from a plurality of stacked trays to a pick and place device for loading or unloading work pieces to or from the trays. The method 200 begins at 201 by determining whether the most recently singulated tray is the last tray to be processed at block 203. This can be done in a number of ways. First, for example, by a signal from the sensor 56 (FIG. 6) that there are no more trays in the tray unloading zone along with another sensor (not shown) indicating there are no more stacks of trays in the infeed buffer zone 16 (FIG. 1). Alternatively, for example, the controller 60 (FIG. 6) can store the lot size of trays that are to be run and a counter can be incremented by the sensor 56 against the desired lot size. If the last tray has been processed then control passes to block 205 and the method is completed.

Otherwise, control passes to block 207 where the shuttle 68 is moved to the second position 34 (FIG. 5). The tray is released in the handling zone 30 in block 209, and the tray is simultaneously released in the unloading zone 20 in block 211. After both trays are released, control passes to block 213 where the pick and place device 12 loads or unloads work pieces to or from the tray in the handling zone 30. Whether the last work piece in the tray has been handled is determined in block 215. This can be determined in a number of ways, such as by using optical sensors or by storing the number of work pieces to be loaded or unloaded to or from the tray. If the decision in block 215 is no, then control returns to block 213; if yes, then control passes to block 203 and the process begins over.

While the pick and place 213 operation is underway, parallel operations can be undertaken to move the shuttle 68 to the first position 217, index the platform 64 to the stacking position 219, singulate the next tray 221, determine if no more trays are in the loading zone 223, and determine if no more trays are to be stacked in the unloading zone 225. If the decision in block 223 is yes, then the next stack can be delivered from the infeed buffer zone 16 to the tray unloading zone 14. If the decision in block 225 is yes, then the second plurality of stacked trays 22 is can be delivered from the tray unloading zone 20 to the outfeed buffer zone 24.

By operating all the functions associated with shuttling and unstacking/stacking the trays in parallel with the pick and place step 213, continuous picking and placing operations can be achieved which optimizes operating efficiency and throughput.

It will be noted that the number of trays present in the first plurality of stacked work pieces 15 and the second plurality of stacked trays 22 can be one tray or more. That is, when processing begins initially there may be no trays in the tray unloading zone 20. The first tray that is shuttled from the handling zone 30 to the tray unloading zone 20 defines the second plurality of stacked trays, with a stack of one trays. Similarly, when the next-to-the-last tray is singulated in the tray unloading zone that will leave only one tray in the first plurality of stacked trays 15.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the mechanisms used to move the stripping, lifting, clamping and supporting members may vary while maintaining substantially the same functionality without departing from the scope and spirit of the present invention. In addition, although the preferred embodiment described herein is directed to use with a work piece tray, it will be appreciated by those skilled in the art that the teachings of the present invention can be applied to other types of work pieces as well without departing from the scope and spirit of the present invention.

What is claimed is:

1. A handling device presenting trays from a first plurality of stacked trays to a pick and place device for loading or unloading work pieces to or from the trays, and for subsequently restacking the trays to a second plurality of stacked trays, the handling device comprising:
a frame defining a tray loading zone receivingly engaging the first plurality of stacked trays for singulating the trays, a tray unloading zone different from the tray loading zone receivingly engaging the trays for stacking with the second plurality of stacked trays, and a handling zone between the loading and unloading zones operatively presenting the singulated trays to the pick and place device;
a singluating device in the tray loading zone adapted for separating the trays from the first plurality of stacked trays;
a stacking device in the tray unloading zone adapted for joining the trays with the second plurality of stacked trays; and
a shuttle adapted for simultaneously moving one of the trays from the tray loading zone to the work zone while moving another of the trays from the work zone to the tray unloading zone.

2. The device of claim 1 wherein the singulating device comprises:
a platform supporting the first plurality of stacked trays that are stacked substantially along a longitudinal direction;
an actuator indexing the first plurality of stacked trays in the longitudinal direction to a singulating position; and
a stripper member operatively moveable between a retracted position and an extended position, the retracted position clearingly permitting moving the first plurality of stacked trays past a distal end of the stripper member, the extended position disposing the distal end of the stripper member between the outermost tray and the adjacent tray in the singulating position of the first plurality of stacked trays.

3. The device of claim 2 wherein the singulating device further comprises:
a sensor indicating when the first plurality of stacked trays is in the singulating position; and
a controller responsive to the sensor and controlling, in turn, movement of the platform.

4. The device of claim 1 wherein the shuttle is operatively moveable adjacent the outermost tray in the first plurality of stacked trays, the singulating device comprising an end effector supported by the shuttle adapted for gripping the outermost tray in the first plurality of stacked trays and displacing the outermost tray away from the stacked trays in the first plurality of stacked trays.

5. The device of claim 4 wherein the end effector comprises:
a linear actuator comprising a fixed end attached to the shuttle;
a suction lifting device attached to an extensible distal end of the actuator and thereby moveable to an engaging relationship against the outermost work piece; and
a vacuum source in fluid communication with the suction lifting device.

6. The device of claim 4 comprising a second end effector supported by the shuttle adapted for gripping a tray in the handling zone simultaneously to the end effector gripping the outermost tray in the tray loading zone.

7. The device of claim 1 further comprising a reference surface in the handling zone adapted for positively positioning a tray relative to the pick and place device.

8. The device of claim 7 further comprising a clamp moveable to fix the tray positioned by the reference surface in the handling zone.

9. The device of claim 6 wherein the shuttle is operatively moveable between a first position and a second position, the first position defined by the end effector adjacent the tray loading zone and the second end effector adjacent the handling zone, the second position defined by the end effector adjacent the handling zone and the second end effector adjacent the tray unloading zone.

10. The device of claim 9 wherein the trays are moved by a process comprising:
moving the shuttle to the first position;
gripping the outermost tray in the first plurality of stacked trays with the end effector;
gripping the tray in the handling zone with the second end effector;
moving the shuttle to the second position; and
releasing the outermost tray in the handling zone with the end effector; and
releasing the tray in the tray unloading zone with the second end effector.

11. The device of claim 10 wherein the trays are moved by a process further comprising:
moving the shuttle to the first position simultaneously while the pick and place device is loading or unloading work pieces to or from the tray in the handling zone.

12. The device of claim 1 wherein the stacking device comprises:
a platform supporting the second plurality of stacked trays that are stacked substantially along a longitudinal direction;
an actuator positioning the platform and thereby indexing the second plurality of stacked trays in the longitudinal direction to a stacking position adapted for receivingly engaging another tray in the second plurality of stacked trays.

13. The device of claim 12 wherein the stacking device further comprises:
a sensor indicating when the second plurality of stacked trays is in the stacking position; and
a controller responsive to the sensor and controlling, in turn, the actuator.

14. The device of claim 11 wherein the trays are moved by a process further comprising simultaneously moving the shuttle between the first and second positions and moving the second plurality of stacked trays to the stacking position.

15. The device of claim 11 wherein the trays are moved by a process further comprising simultaneously moving the shuttle between the first and second positions and moving the first plurality of stacked trays to the singulating position.

16. A method for presenting trays from a first plurality of stacked trays to a pick and place device for loading or unloading work pieces to or from the trays, and for subsequently restacking the trays to a second plurality of stacked trays, the method comprising:
singulating a first tray in the first plurality of stacked trays;
shuttling the first tray to a handling zone operatively adjacent the pick and place device;
moving work pieces from or to the tray in the handling zone with the pick and place device and simultaneously singulating a second tray in the first plurality of stacked trays;
when the handling operations on the first tray are complete, simultaneously shuttling the first tray from the handling zone to the second plurality of stacked trays while shuttling the second tray from the first plurality of stacked trays to the handling zone.

17. The method of claim 16 wherein the singulating step comprises retaining the trays other than the first tray in the first plurality of stacked trays while the first tray is separated.

18. The method of claim 16 comprising the step of clamping the tray in the handling zone while picking and placing work pieces.

19. A tray handling device, comprising:
a tray loading zone supporting a first plurality of stacked trays and a tray unloading zone supporting a second plurality of stacked trays; and
means for shuttling trays from the first to the second plurality of stacked trays and staging the trays therebetween in a handling zone adapted for communicating with a pick and place device for continuous picking and placing operations on work pieces to and from the trays.

20. The device of claim 19 wherein the means for shuttling is characterized by a shuttle adapted for simultaneously moving one of the trays from the tray loading zone to the work zone while moving another of the trays from the work zone to the tray unloading zone.

21. The device of claim 20 wherein the means for shuttling is characterized by a process comprising:
moving a shuttle to a first position wherein a first end effector is adjacent the first plurality of stacked trays;
gripping the outermost tray in the first plurality of stacked trays with the end effector;
gripping a tray in the handling zone with a second end effector;
moving the shuttle to a second position whereat the first end effector is adjacent the handling zone and the second end effector is adjacent the tray unloading zone; and
releasing the outermost tray in the handling zone with the first end effector; and
releasing the tray in the tray unloading zone with the second end effector.

22. The device of claim 21 wherein the means for shuttling is characterized by a process further comprising:
simultaneously moving the shuttle to the first position while the pick and place device is loading or unloading work pieces to or from the tray in the handling zone.

23. The device of claim 22 wherein the means for shuttling is characterized by a process further comprising simultaneously moving the shuttle between the first and second positions and moving the second plurality of stacked trays to a stacking position for receivingly engaging a tray for stacking.

24. The device of claim 22 wherein the means for shuttling is characterized by a process further comprising simultaneously moving the shuttle between the first and second positions and moving the first plurality of stacked trays to a singulating position for separating a tray.
